(19) United States
(12) Patent Application Publication
(10) Pub. No.: US 2010/0276939 A1
(43) Pub. Date: Nov. 4, 2010

(54) GENERATING ELECTRICITY USING WIND

(76) Inventor: Manfred Clynes, Sonoma, CA (US)

Correspondence Address: FISH & RICHARDSON PC, P.O. BOX 1022, MINNEAPOLIS, MN, 55440-1022, US

(21) Appl. No.: 12/487,447

(22) Filed: Jun. 18, 2009

Related U.S. Application Data
(63) Continuation-in-part of application No. 12/433,662, filed on Apr. 30, 2009.

(51) Int. Cl. F03D 9/00; G09F 21/06

(52) U.S. Cl. 290/55; 40/214

(57) ABSTRACT

Among other things, wind energy can be harnessed without using an outmoded rotational windmill model, which is inherently inefficient because much of the wind energy is bypassed; blade stresses are pronounced; and there is a danger to birds, animals, and in smaller models to people. Efficiency directs rotational devices to be quite large, unaesthetic, and a slur on the environment. Here, the quasi-random movements of hundreds of flexible flaps, called wixels, in an array generates electricity through neodymium magnets and wire coils which move relatively to one another in the wind. Each flap generates small amounts of electricity; the random-like contributions of the many flaps are added electronically using standard methods. The sum is fed negatively into the grid, as in solar panel arrays. Multiple arrays can be arranged as wind farms or can be used on rooftops or back yards without danger. Various colored wixels provide for mobile artistic design, an environmental plus, and in large installations for advertising.

This application is a continuation-in-part of U.S. patent application Ser. No. 12/433,662, filed Apr. 30, 2009, and incorporated here by reference in its entirety.

### BACKGROUND

This description relates to generating electricity using wind.

The swaying of a tree in the wind is driven by its leaves. The structure of the tree inherently aggregates the small individual energy contributions of the large number of leaves into enough energy to sway even a very large tree.

For centuries, windmills have been used to extract energy from the wind and apply it to tasks such as milling wheat between rotating stones and more recently generating electricity for broad distribution to users.

Some considerations in the design and operation of electricity generating windmills (sometimes called wind turbines) are efficiency, cost and practicality of construction, safety (to birds, animals, and humans), environmental impact, aesthetics (some people think wind turbines are ugly), and energy storage (e.g., using batteries).

One measure of efficiency of a wind turbine is the percentage of the total energy of the wind that could be potentially captured in the geometrical area that is swept by its rotating blades, that is actually captured. Efficiency is maximized when the blades rotate fast enough to maximally scoop the wind passing through that area, but not so fast as to cause the blades to cavitate (lose traction because air cannot flow fast enough through that area).

Yet the blades of a typical wind turbine rotate much more slowly than this ideal speed, and much of the available wind energy is lost as it blows through that area without doing work on the blades. In addition, wind turbine blades tend to operate at high efficiency only along about two thirds of their length; their efficiency is lower in blade segments that are near the center of rotation (where they move more slowly for a given wind speed) and also near their outer ends.

Wind turbine blades and the structures that support them must be carefully designed and built because they are large, heavy, subjected to large stresses and vibrations, must last a long time, must be stabilized at the ground, and need to rise high above the ground to catch winds that are steady rather than unpredictable and random.

An elegant way to derive value from even small amounts of generated electricity is to use it to drive the electricity distribution grid negatively to offset the cost of electricity that would otherwise be drawn from the grid.

### SUMMARY

In general, in an aspect, a wind catching surface is supported to face an oncoming wind and not to rotate continuously in one direction under the influence of the oncoming wind, and an energy converter converts motion, caused by the surface catching the oncoming wind, into electricity.

Implementations may include one or more of the following features. One or more elements supporting the wind catching surface are configured to increase randomness of motion of the wind catching surface relative to the oncoming wind. The element comprises a primary support of a portion of the wind catching surface and the element has non-uniformities of shape, e.g., nodes along the primary support. The element comprises a secondary support and the element has non-uniformities of shape, e.g., an S-shape. The wind catching surface is fixed at one edge and at least some other portions are free to move in response to the wind. The wind catching surface is supported to face the oncoming wind directly. The wind catching surface is arranged to alter its configuration in response to the oncoming wind. The wind catching surface is arranged to billow in response to the oncoming wind. The wind catching surface is generally rectangular. The wind catching surface includes a stem. The stem is coupled to the energy converter. The wind catching surface is fixed at one edge and is coupled at another location to the energy converter. The motion caused by the surface catching the oncoming wind includes linear motion of the energy converter. The wind causes a distance between the fixed pitch and the coupled location to vary.

The energy converter includes an electromagnetic device. The energy converter includes a magnet and a coil that move relative to one another. The energy converter includes reciprocating elements. There is also a half-wave and/or a full-wave rectifier.

Implementations for restoring force may include one or more of the following features. An element applies a restoring force in response to the motion. The element that applies a restoring force includes a spring. The element that applies a restoring force includes a mass that is acted on by gravity, which may be the weight and elasticity of the wixel itself.

There is a support for the wind catching surface. There is at least one additional wind catching surface on the support. The support is stationary relative to the wind. The support has nodal points of resonance to impart a randomized elasticity to the support. The support is movable to orient the wind catching surface relative to a direction of the wind. The wind catching surface and the additional wind catching surface are mounted to prevent interference with one another in the wind.

In general, in an aspect, at a wind catching surface, an oncoming wind is received that varies unpredictably in speed and direction over time. Motion, which is caused by the surface catching the unpredictably varying wind and is not continuous rotational motion in one direction, is converted into electricity.

In general, in an aspect, a wind catching surface is supported to face an oncoming wind and not to rotate continuously in one direction under the influence of the oncoming wind, and a linear electromagnetic energy converter converts back and forth linear motion, caused by the surface catching the oncoming wind, into electricity.

In general, in an aspect, two or more independently movable wind catching surfaces are supported in common to face an oncoming wind and to exhibit different motions at a given time in response to the oncoming wind. An energy converter converts the different motions into electricity.

Implementations may include one or more of the following features. There is an array of the wind catching surfaces. The array includes rows and columns of generally rectangular wind catching surfaces. There is a supporting structure for the wind catching surfaces, the supporting structure and the wind catching surfaces comprising a wind screen. There are additional such wind screens, and the wind screens are coupled to provide electricity to electricity distribution grid.

In general, in an aspect, at least two wind catching surfaces are supported to face and to move in response to an oncoming wind. An energy converter converts the motion into electricity. Text, colors, and/or images are arranged on the wind catching surfaces and are configured to provide visual effects that depend on motion of the surfaces in response to the oncoming wind. The text and/or images include advertising. The visual effects embody artistic creativity and individual satisfaction and are capable of changes of design over time.

These and other features and aspects, and combinations of them, can be expressed as methods, apparatus, systems, components, means and steps for performing functions, business methods, and in other ways.

Other aspects, features, and advantages will be apparent from the following description and the claims.

### DESCRIPTION

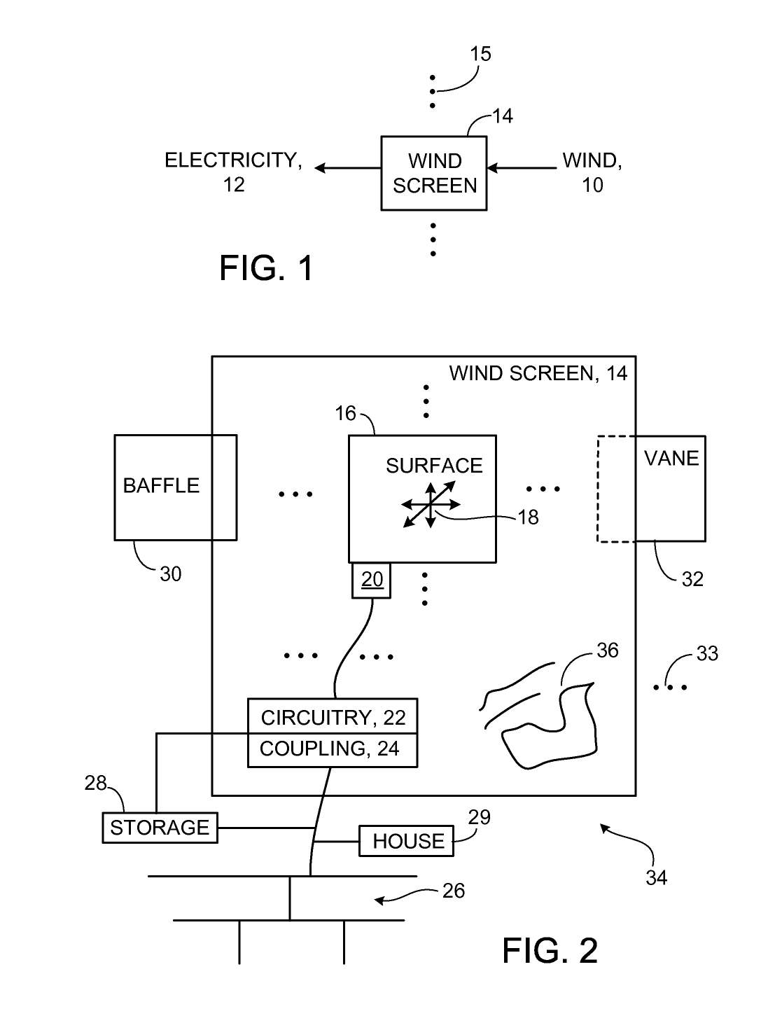

FIG. 1 is a schematic block diagram.

FIG. 2 is a schematic view of wind screen.

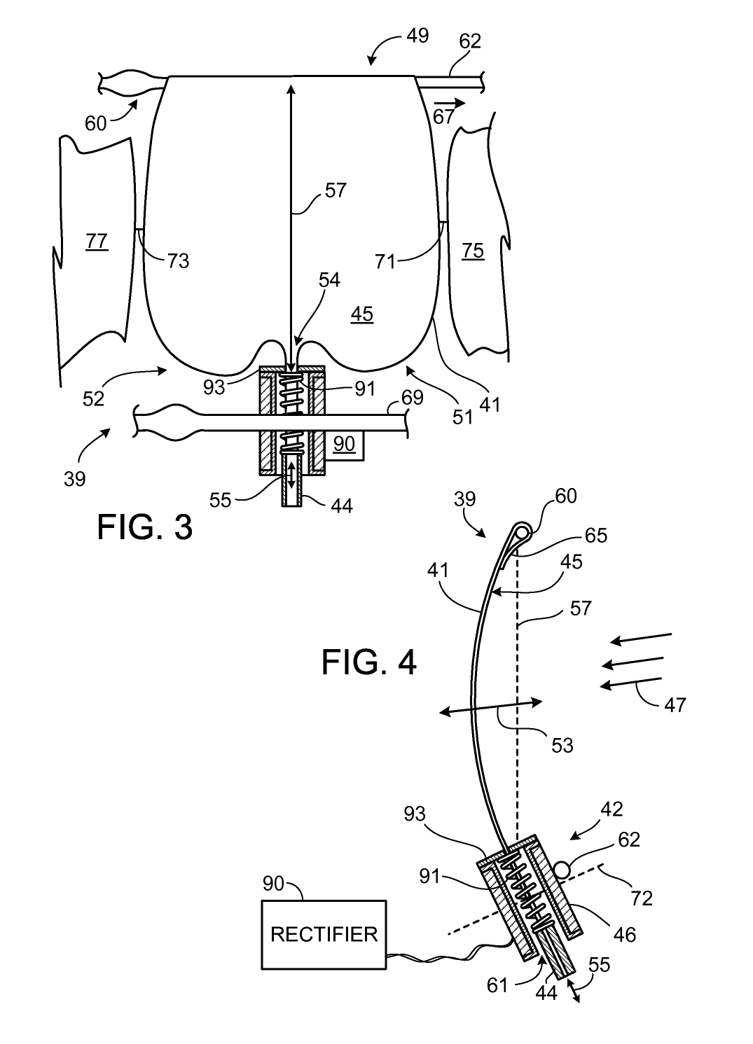

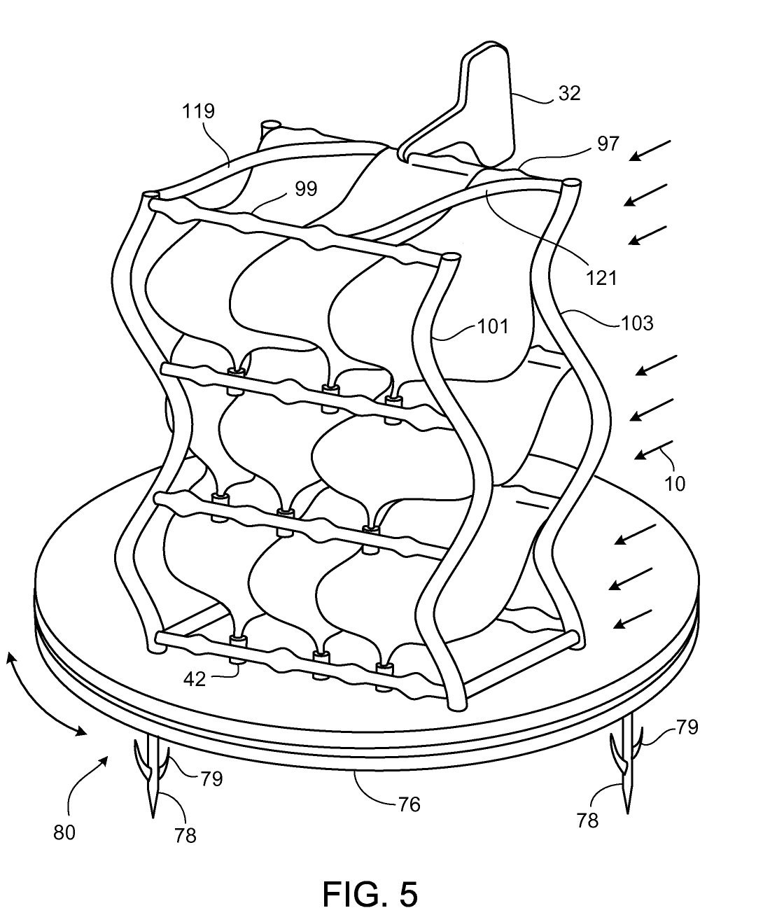

FIGS. 3 and 4 are top and side views of a wixel.

FIG. 5 is a perspective view of a wind screen.

As shown schematically in FIG. 1, energy from oncoming wind 10 can be used to generate electricity 12 efficiently, using easily and inexpensively made wind screens 14 that can be replicated 15 (for example, in very large numbers) and distributed widely. The wind screens 14 rely on motion generated by the oncoming wind and need not rely on continuous rotational motion in one direction (as do typical wind turbines), but can simply be faced head-on into the oncoming wind and generate electricity by other kinds of motion caused by the wind. The wind screens can have small environmental footprints, can be aesthetically inoffensive or even pleasing, be mass produced cheaply and easily, and be made widely available.

As shown schematically in FIG. 2, in some implementations, each of the wind screens 14 includes one or more wind facing (e.g., wind catching) surfaces 16, which are part of what we sometimes call wixels (for Wind pIXELS). Each of the wixels undergoes quasi random movements 18 in response to the wind. An energy transducer 20 is driven by the movement in each wixel to generate electricity. Although the amount and direction of the electricity generated by each of the wixels may be small, bi-directional, quasi-random, and variable over time (because, for example, of the unpredictability of the wind), circuitry 22 can be used to aggregate the respective electricity contributions of the wixels, using standard methods, for example. The aggregated electric energy can then be fed through a coupler 24 and applied negatively to a public or private electricity distribution grid 26, much as the electricity produced by solar cells in a solar panel array can be aggregated and fed to the grid.

Electric energy storage devices 28 (such as batteries) can store the generated electric energy temporarily or over a longer term to smooth variations in energy generation as the wind varies. With batteries to even out the electricity supply, it should be possible to use wind screens to supply the needs of, for example, an average house 29 at modest cost, instead of or in addition to returning the power to the grid.

A baffle 30 in front of and a vane 32 behind the array can help to randomize the impact of the wind on the wixels. If the wind screen is movable, the vane can cause the wind screen 14 to face the wind as the wind direction changes. The baffle helps to mix the wind and to deflect it in quasi-random directions toward the wixels.

Each of the wind screens 14 may contain one, a few, a dozen, hundreds, or even thousands of wixels. A small or large (or very large) number 33 of wind screens can be arranged to form a wind farm 34.

Aesthetic features 36 can be imparted to individual wixels, to parts of wixels, to wind screens containing wixels, to groups of such wind screens and in combinations that span multiple wixels or windscreens. Colors, shapes, sizes, patterns, texts, advertising, textures, surfaces, images, and other aesthetic features can be used to enhance small or large installations, say, and also for commercial advertising or other purposes. The varied movements of the wixels and the wind screens that contain them can produce intriguing visual effects, much as do colored flags dancing in the wind. Very low power lights (although they would be energy drains) could be selectively attached to the wixels or the wind screens to add visual interest, especially at night. Different wixels may be colored differently to present attractive visual impressions. Wixels may also be patterned selectively, including using shiny portions (for example, silver, gold, or copper colored, but not metal). The images or text of signs may be attractive as the pattern moves with the wind, seductively or teasingly, so that the viewer sees the text or picture at times and at other times does not.

As shown in FIGS. 3 and 4, in some examples, each wixel 39 includes a flexible flap 41 that exposes its surface 45, for example, directly into (that is, faces, or catches) the wind 47. In the wind, the flap of each of the wixels moves and flexes quasi-randomly 53. Each flap is attached at one end 49 (e.g., along one edge) to a horizontal bar that is part of the wind screen. At the other end 51, the flap is connected to an energy transducer (e.g., a linear electromagnetic transducer) 42 that includes a neodymium magnet 44 and a coil of wire 46. The magnet and coil of wire move linearly relative to one another when the flap flexes or moves in the wind. Either the magnet is attached to a part of the wind screen and the coil is attached to the flap at the stem or elsewhere, or vice versa.

In general, the design of the flap, its attachment to the support, and the operation of the energy converter should be directed to producing the smallest possible amount of friction and chance of jamming. A Teflon antifriction coating or element may be helpful.

The motion of the wixel back and forth 53 in the wind is translated to back and forth motion 55 of the electromagnetic transducer, generating electricity. In some implementations, the coil may be similar to those used in solenoids; in other examples, the coil could be formed integrally in the flap or the stem of the flap.

In some examples, when the wind strikes the flap of a wixel it causes a flexing, billowing, or other reconfiguration of the flap which causes the effective length 57 of the flap between the end that is attached to the wind screen and the end that is connected to the energy transducer to vary, thus inducing the generation of electrical energy.

As shown in FIGS. 3 and 4, the flap of each wixel 49 can be generally rectangular, made of flexible plastic, and not necessarily of uniform thickness. One edge 52 of the wixel can be tapered to form (or be attached to) a stem 54. The magnet 44 is mounted on the stem and can move freely back and forth within an internal channel 61 formed within and along the length of the coil of wire. An opposite edge 60 of the wixel flap is attached to a cross bar 62, for example by wrapping the edge around the bar and gluing or sealing it 65 along the opposite surface of the flap. A series of such wixels can easily be mounted along the length 67 of a long cross bar.

The coil of wire 46 is mounted on another cross bar 69, parallel to the cross bar 62, so that the flap is suspended between the two rods and is separated by small spaces 71, 73 from the adjacent wixels 75, 77. The spacing helps to assure that adjacent wixels will not strike or otherwise interfere with one another, which would dissipate energy from the wind uselessly. Each support rod (cross bar) may have thicker nodules 97, 99 spaced along its length to provide multiple nodal points of resonance thereby providing a randomized elasticity function, which may aid in making the wind appear more random to the wixels. In addition, the vertical supports 101, 103 to which the ends of the cross-bars are attached cross braces 119, 121 between the upper pair of cross bars may be shaped as s's or in other ways that will contribute to the randomness of the motion of the wixels.

Although the flap of the wixel is generally rectangular, as shown in FIG. 3, the edge of the flap may be curved for aesthetic reasons and to enhance the randomization of the impact of the wind by promoting irregular flow of air to a degree. The stem may be integrally extruded with the flap of the wixel and made of the same plastic material.

By attaching a relatively long edge of the flap along the rod 62, that edge is stabilized and twisting of the flap out of its original orientation (e.g., plane) is dampened in favor of motion and reconfiguration of the flap surface generally at right angles to its original plane. For example, the flap of the wixel moves forward and backward 53 preferentially. As the flap surface moves forward and backward and the contour of the flap changes, the distance 57 between the edge that is attached to rod and the stem 54 varies causing the magnet to move in and out of the coil which is attached to the next adjacent cross bar 70 of the wind screen.

In the example of FIG. 4, when the flap is in its relaxed position as shown, a helical spring 91 (that pushes off a cap 93 at the top of the coil) at the bottom end of the stem of the flap urge the magnet to an extended downward position along the length of the coil. When the wind strikes the flap from the left side of FIG. 4, causing the flap to billow to the right, the stem of the flap is pulled up and pulls the magnet up along the interior of the coil, generating electricity. When the wind stops, the flap relaxes and the weight and spring force the magnet to its original position, again generating electricity. Random action of the wind on the flap will cause oscillation of the magnet within the coil generating small randomized amounts of energy in opposite directions over time.

In this example, the wixel is arranged so that the wind moves and reconfigures the flap somewhat like a billowing sail, blowing it into a temporarily more concave shape, with some twisting allowed, and pulling the stem and magnet in a direction parallel to the axis of the coil. The farther the magnet moves back and forth away from a normal position 72 (at which it rests when there is no wind, for example), the larger is a restoring force that is arranged to tend to pull the magnet back to the normal position. The restoring force can be the produced by elasticity of the wixel flap material, the gravitational force on the magnet and wixel flap if the coil is so angled to the vertical, or by a non-ferrous coiled spring held within the electrical coil, as commonly used in solenoids, or a combination of these.

The randomness and the variability of the strength of the wind (and its direction) as it strikes each of the wixels moves the electromagnetic transducer to and fro and enables energy to be extracted. In some examples, the generation of electricity depends on this variability of the wind and would not work as well or at all in a steady wind (as do conventional wind turbines). To the extent that the to and fro movement causes electricity generation there will also be a natural electromagnetic damping action on the movements of the flaps. For this reason, elements that impart randomness are incorporated in the wixel flaps, the cross bars, and the vertical supports for the cross bars, among other things.

A double rectifier arrangement 90 can be provided inexpensively for each wixel to capture energy generated during both forward and backward motion of the wixel in the wind and to provide a natural braking action in both directions. The braking action can be electrically adjusted using resistive elements in the circuitry 22 (FIG. 2). Dissipating energy in resistors is not typically desirable, unless the resistive elements are a useful electrical load that is being powered by the wixels.

The coupling 24 (FIG. 2) that is used to deliver the energy negatively to the grid must convert the electricity to 60-cycle AC (for example, in the United States), just as must be done with collected solar energy. Solid state inverters and converters in the coupling can be directly connected to the electricity grid for this purpose.

As shown in FIG. 5, in some implementations, each of the wind screens 14 could include a pedestal 76 configured to stabilize the wind screen in the wind 10 and to prevent a strong wind from overturning it. When the wind screens are deployed on the ground, the pedestal can be held by four posts 78 driven into the ground. Each post has spurs 79 that prevent or resist the pedestral from being pulled up and out of the ground once installed. In some examples, the pedestal can include a mechanism 80 that enables the wind screen to rotate to catch the wind while providing a degree of damping to rotation so that the wind screen does not react too rapidly or too completely to shifts in the wind direction. For example, the rotational mechanism could permit rotation of the wind screen to react only to an average wind direction over time.

When multiple wind screens are deployed together in a wind farm, they can be placed in a pattern to reduce the negative effect of the wind-shadow cast by each of the wind screens on the ability of each of the other wind screens to catch the wind.

It is desirable for different wixels of a given wind screen to move randomly but not so that the flaps knock against one another. Mechanical interference from one flap to another would diminish the output and cause unnecessary wear.

In some examples, each of the flaps could be about 5 inches wide and 7 inches long. The screen could be rectangular and on the order of five feet on a side. There could be 12 wixels in each row and 15 wixels in each column of the array, for a total of 180 wixels. Pairs of rods spanning the wind screen would provide support for the static ends of the flaps and the coils associated with the movable stem ends. Each coil could have 200 turns of wire.

The amount of electricity that can be generated depends on a wide range of parameters, including the characteristics of the wind, its speed and variability, the mechanical configuration of the coil and magnet in the energy converter. The performance of a wixel or a wind screen or a farm of wind screens will depend on optimizing the relevant parameters in its manufacture. Each wixel could generate an average 10 watt hours per day in smaller installations of eight or ten wind screens or about 2 kilowatt hours per day for a wind screen when the average wind speed is in the range of 10-15 mph. (a small installation might have 8-10 screens). In a larger installation (say with screens sized 15 feet by 21 feet each), ten times as much energy, or more, per wixel, may be generated, depending on wind. Actual performance may be better or worse then these projections.

Elasticity is an important consideration in designing the frame of the wind screen, especially for larger installations. It may be useful to consider the branches of trees as they move along with the smaller branches and leaves, in a dance that is intriguing and protective. The branches provide multiple center of masses each having eigenfunctions that result in movements that have many natural frequencies of damped oscillation. The total effect is rather unpredictable, but has a stable and strong organic aspect.

Other implementations are within the scope of the following claims.

For example, a very wide range of shapes, sizes, configurations, materials, weights, elasticities, orientations, and other parameters could be used for each of the flaps. In determining a good size for a particular application, the following considerations are pertinent: Larger installations could generally have larger wixels, but the maximum size may be determined by the strength and life span of the plastic or other material used for the flaps. Sail design considerations may be relevant. Sails are subject to similar but not identical stresses. Fluttering of sails is suggestive of some of the behavior of wixels (but in wixels is less pronounced). The wind encountered by a flap is proportional to its area, and the impact of the wind is proportional to the cube of wind velocity. So a steep increase in wind force can be implied by larger flap size.

The flaps that form part of a given wind screen can respectively exhibit two or more different shapes, sizes, configurations, materials, weights, elasticities, orientations, or other parameters, as well as different aesthetic features. These different features can be selected to serve functional purposes, to improve the generation of electricity, the durability of the pieces, and to serve other functions. The modes of motion that characterize different flaps within a given wind screen can also be different.

The orientation of each flap could be different than in the examples. For example, in some implementations, the stem could point up instead of down. Then the weight of the magnet would reinforce (rather than oppose) the effect of the wind. In some examples, a mechanism could be provided so that the stem would be tilted at different angles to vertical depending on the strength of the wind. Although, when the weight of the magnet is used as a restoring force pointing the stem of the flap upward may produce more friction and lose the advantage of a cleaning motion congruent with the action of the wixel as it is being pulled forward.

A wide variety of different energy conversion techniques can be used. Other electromagnetic conversion modes, not limited to linear motion, may be useful. Conversion to electricity through other mechanisms than electromagnetism may be fruitful.

The speed of the movement of the magnets on the stem of a flap past the coil within which it rides is an important factor in how much electricity can be generated. While the speed will be much slower than in typical rotating generators of power plants, it is still effective, at a smaller scale. Electrical generation is proportional to relative velocity. In any case, it may be possible to enhance the speed of motion of the magnet within the coil by a speed leveraging mechanism.

The restoring spring may be weaker or stronger and may even be omitted depending on whether and how the rectifiers are used. Since the voltages generated at each wixel are small, rectifiers may not work as efficiently as desired in light winds. In most existing wind energy installations, a wind of 5 mph is considered as a low cutoff point. With the use of wixels, a lower cutoff point may be possible.

Wind screens and groups of them can be deployed in a wide variety of contexts, environments, locations, and in many different ways for a broad range of purposes.

They can be used on roof tops and in back yards of houses and in public places, without danger to birds, animals, or humans, for example. An entire wind screen could be mounted high in a tree, and in forested areas on many trees, perhaps about two thirds up the tree on moderately large trees to catch the wind. In such a deployment, a cylindrical swivel mounting could be used together with a vane to permit the wind screen to swivel freely into the wind.

Other implementations are within the scope of the following claims.

1. An apparatus comprising
a wind catching surface supported to face an oncoming wind and not to rotate continuously in one direction under the influence of the oncoming wind, and
an energy converter that converts motion, caused by the surface catching the oncoming wind, into electricity.

2. The apparatus of claim 1 in which the wind catching surface is fixed at one edge and at least some other portions are free to move in response to the wind.

3. The apparatus of claim 1 in which the wind catching surface is supported to face the oncoming wind directly.

4. The apparatus of claim 1 in which the wind catching surface is arranged to alter its configuration in response to the oncoming wind.

5. The apparatus of claim 4 in which the wind catching surface is arranged to billow in response to the oncoming wind.

6. The apparatus of claim 1 in which the wind catching surface is generally rectangular.

7. The apparatus of claim 1 in which the wind catching surface comprises a stem.

8. The apparatus of claim 7 in which the stem is coupled to the energy converter.

9. The apparatus of claim 1 in which the wind catching surface is fixed at one edge and is coupled at another location to the energy converter.

10. The apparatus of claim 9 in which the motion caused by the surface catching the oncoming wind comprises linear motion of the energy converter.

11. The apparatus of claim 9 in which the wind causes a distance between the fixed pitch and the coupled location to vary.

12. The apparatus of claim 1 in which the energy converter comprises an electromagnetic device.

13. The apparatus of claim 1 in which the energy converter comprises a magnet and a coil that move relative to one another.

14. The apparatus of claim 1 in which the energy converter comprises reciprocating elements.

15. The apparatus of claim 1 also comprising an element that applies a restoring force in response to the motion.

16. The apparatus of claim 15 in which the element that applies a restoring force comprises a spring.

17. The apparatus of claim 15 in which the element that applies a restoring force comprises a mass that is acted on by gravity.

18. The apparatus of claim 17 in which the mass comprises the wind catching surface.

19. The apparatus of claim 15 in which the restoring force comprises a natural elasticity of the wind catching surface.

20. The apparatus of claim 1 also comprising a support for the wind catching surface.

21. The apparatus of claim 20 also comprising at least one additional wind catching surface on the support.

22. The apparatus of claim 20 in which the support is stationary relative to the wind.

23. The apparatus of claim 20 in which the support comprises nodal points of resonance to impart a randomized elasticity to the support.

24. The apparatus of claim 20 in which the support is movable to orient the wind catching surface relative to a direction of the wind.

25. The apparatus of claim 21 in which the wind catching surface and the additional wind catching surface are mounted to prevent interference with one another in the wind.

26. A method comprising
receiving, at a wind catching surface, an oncoming wind that varies unpredictably in speed and direction over time, and
converting motion, which is caused by the surface catching the unpredictably varying wind and is not continuous rotational motion in one direction, into electricity.

27. The method of claim 26 in which the wind catching surface is oriented to face the oncoming wind.

28. The method of claim 26 in which receiving the oncoming wind comprises altering the configuration of the wind catching surface in response to the wind.

29. The method of claim 26 in which the motion is converted to electricity electromagnetically.

30. An apparatus comprising
a wind catching surface supported to face an oncoming wind and not to rotate continuously in one direction under the influence of the oncoming wind, and
a linear electromagnetic energy converter that converts back and forth linear motion, caused by the surface catching the oncoming wind, into electricity.

31. The apparatus of claim 27 in which the wind catching surface is fixed at one edge and at least some other portions are free to move in response to the wind.

32. The apparatus of claim 27 in which the wind catching surface is supported to face the oncoming wind directly.

33. The apparatus of claim 27 in which the wind catching surface is arranged to alter its configuration in response to the oncoming wind.

34. The apparatus of claim 30 in which the wind catching surface is arranged to billow in response to the oncoming wind.

35. The apparatus of claim 27 in which the wind catching surface is generally rectangular.

36. The apparatus of claim 27 in which the wind catching surface comprises a stem.

37. The apparatus of claim 33 in which the stem is coupled to the energy converter.

38. The apparatus of claim 27 in which the wind catching surface is fixed at one edge and is coupled at another location to the energy converter.

39. The apparatus of claim 35 in which the wind causes a distance between the fixed edge and the coupled location to vary.

40. The apparatus of claim 27 in which the energy converter comprises a magnet and a coil that move relative to one another.

41. The apparatus of claim 27 in which the energy converter comprises reciprocating elements.

42. The apparatus of claim 27 also comprising an element that applies a restoring force in response to the motion.

43. The apparatus of claim 39 in which the element that applies a restoring force comprises a spring.

44. The apparatus of claim 39 in which the element that applies a restoring force comprises a mass that is acted on by gravity.

45. The apparatus of claim 27 also comprising a support for the wind catching surface.

46. The apparatus of claim 42 also comprising at least one additional wind catching surface on the support.

47. The apparatus of claim 42 in which the support is stationary relative to the wind.

48. The apparatus of claim 42 in which the support is movable to orient the wind catching surface relative to a direction of the wind.

49. The apparatus of claim 43 in which the wind catching surface and the additional wind catching surface are mounted to prevent interference with one another in the wind.

50. Apparatus comprising
two or more independently movable wind catching surfaces supported in common to face an oncoming wind and to exhibit different motions at a given time in response to the oncoming wind, and
and energy converter that converts the different motions into electricity.

51. The apparatus of claim 47 in which there is an array of the wind catching surfaces.

52. The apparatus of claim 48 in which the array comprises rows and columns of generally rectangular wind catching surfaces.

53. The apparatus of claim 47 also comprising a supporting structure for the wind catching surfaces, the supporting structure and the wind catching surfaces comprising a wind screen.

54. The apparatus of claim 50 in which there are additional such wind screens, and the wind screens are coupled to provide electricity to electricity distribution grid.

55. Apparatus comprising
at least two wind catching surfaces supported to face and to move in response to an oncoming wind,
an energy converter that converts the motion into electricity, and
text, colors, and/or images arranged on the wind catching surfaces and configured to provide visual effects that depend on motion of the surfaces in response to the oncoming wind

56. The apparatus of claim 55 in which the text and/or images comprise advertising

57. The apparatus of claim 53 in which the visual effects embody artistic creativity and individual satisfaction and are capable of changes of design over time.

58. The apparatus of claim 1 also comprising at least one element supporting the wind catching surface and configured to increase randomness of motion of the wind catching surface relative to the oncoming wind.

59. The apparatus of claim 58 in which the one element comprises a primary support of a portion of the wind catching surface and the element has non-uniformities of shape.

60. The apparatus of claim 59 in which the non-uniformities comprise nodes along the primary support.

61. The apparatus of claim 58 in which the element comprises a secondary support and the element has non-uniformities of shape.

62. The apparatus of claim 61 in which the non-uniformities comprise an S-shape.

63. The apparatus of claim 1 also comprising a half-wave and/or a full-wave rectifier.
